(19) United States
(12) Patent Application Publication
(10) Pub. No.: US 2005/0263966 A1
(43) Pub. Date: Dec. 1, 2005

(54) Tandem axle with swivel wheels

(76) Inventor: Ralph L. Barnett, Wilmette, IL (US)

Correspondence Address: Pauley Petersen & Erickson, Suite 365, 2800 West Higgins Road, Hoffman Estates, IL, 60195, US

(21) Appl. No.: 11/098,188

(22) Filed: Apr. 4, 2005

Related U.S. Application Data
(60) Provisional application No. 60/575,886, filed on Jun. 1, 2004.

(51) Int. Cl. B62B 5/02

(52) U.S. Cl. 280/5.28

(57) ABSTRACT

A tandem axle wheel replacement apparatus having swiveling wheels helps eliminate abrupt jarring or stopping when wheeled conveyances, such as walkers, wheeled-chairs, carts, or the like, encounter obstacles to the forward motion of their wheels. Thus, the apparatus reduces the risk of injury and the breaking or jarring of any occupant or contents of the wheeled conveyance. The apparatus further provides increased access and mobility by enabling the traversal of obstacles which would otherwise block forward motion by permitting a wheeled conveyance to maneuver over obstacles more stably, smoothly, and with less effort in both frontal impacts and angular impacts with obstacles.

### CROSS REFERENCE TO RELATED APPLICATION

This application claims the benefit of U.S. Provisional Application No. 60/575,886, filed 01 Jun. 2004.

### BACKGROUND OF THE INVENTION

1. Field of the Invention

This invention relates to a wheeled conveyance having at least one tandem axle wheel assembly which replaces a traditional single axle wheel. More particularly, the invention relates to a tandem axle wheel replacement system having wheels which swivel.

2. Description of Related Art

It is known that a tandem axle wheel replacement allows the wheels to traverse an obstacle while lifting the center of the tandem axle assembly only one half of the obstruction height. A single conventional wheel and axle must rise to the full height of the obstacle as it passes over it. The tandem axle wheel replacement requires half the static horizontal force to traverse an obstruction compared to a single conventional wheel. That is, one half the energy is required for each wheel of the tandem axle wheel replacement to ride over an obstacle using a tandem axle when compared to a single axle with the same wheel.

Unfortunately, existing tandem axle mounted wheels are fixed and do not swivel freely. Therefore existing tandem axle mounted wheels drag sideways when rotated about a substantially vertical axis, inhibiting forward motion of the wheels and thereby limiting access and mobility of a wheeled conveyance and, in some instances, the operator thereof.

### SUMMARY OF THE INVENTION

Accordingly, it is one object of this invention to provide an improved tandem axle wheel replacement for a wheeled conveyance.

It is another object of this invention to provide an improved tandem axle wheel replacement for a wheeled conveyance having swivel wheels which do not inhibit forward motion.

It is another object of this invention to provide an improved tandem axle wheel replacement for a wheeled conveyance which requires reduced static horizontal force to pass over an obstacle.

It is another object of this invention to provide an improved wheeled conveyance providing greater mobility and access for the operator thereof.

These and other objects of this invention are addressed by an improved tandem axle wheel replacement for a wheeled conveyance having swivel wheels. The present invention helps eliminate abrupt jarring or stopping which happens when regular wheeled conveyances, such as walkers, wheeled-chairs, wheeled carts, or the like, either powered or un-powered, encounter obstacles to the forward motion of their wheels. Thus, the present invention makes the wheeled conveyances safer for the rider and reduces the risk of injury and the breaking or jarring of any occupant or contents of the wheeled conveyances.

The present invention may also provide increased access and mobility by enabling the traversal of obstacles which would otherwise block forward motion by permitting a wheeled conveyance to stably maneuver over obstacles smoothly and with less effort in both frontal impacts and angular impacts with obstacles.

In one exemplary embodiment of this invention, the tandem axle wheel replacement includes a double set of tandem axle assemblies, thereby lessening the static horizontal force required to pass over an obstacle to twenty five percent (25%) of the force required by a single conventional wheel.

### BRIEF DESCRIPTION OF THE DRAWINGS

These and other objects and features of the invention will be better understood from the following detailed description taken in conjunction with the appended claims and drawings.

FIG. 1 is a side view of a tandem axle wheel replacement system for a wheeled chair, according to one exemplary preferred embodiment of this invention;

FIG. 2 is a side view of a tandem axle caster wheel replacement according to one preferred embodiment of this invention;

FIG. 3 is a side view of a tandem axle spherical wheel replacement according to one preferred embodiment of this invention;

FIG. 4 is a front view of a dual tandem axle wheel replacement according to one preferred embodiment of this invention;

FIGS. 5-7 illustrate the lessening of the static horizontal force required to pass over an obstacle when using a standard wheel, a tandem axle wheel replacement, and dual tandem axle wheel replacement, respectively.

### DETAILED DESCRIPTION OF PREFERRED EMBODIMENTS

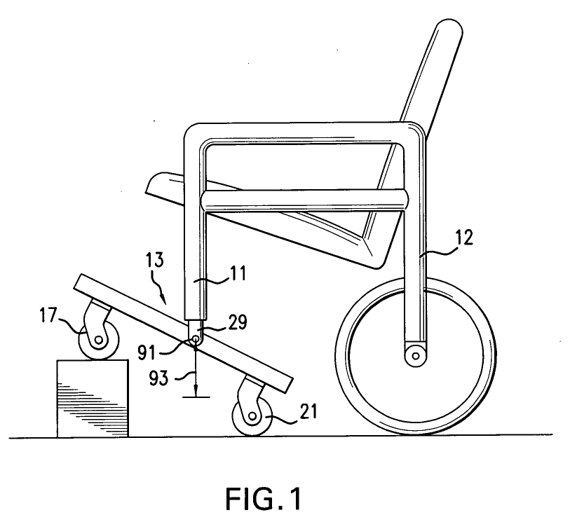

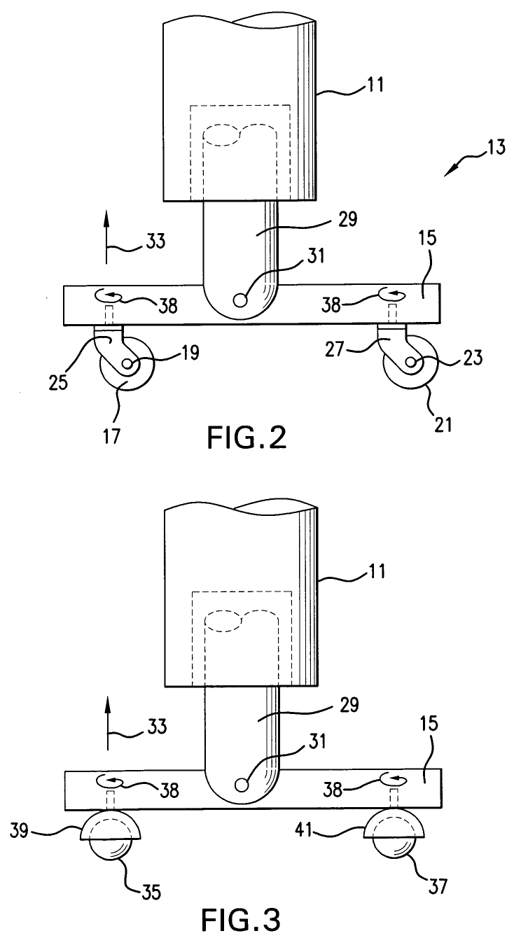

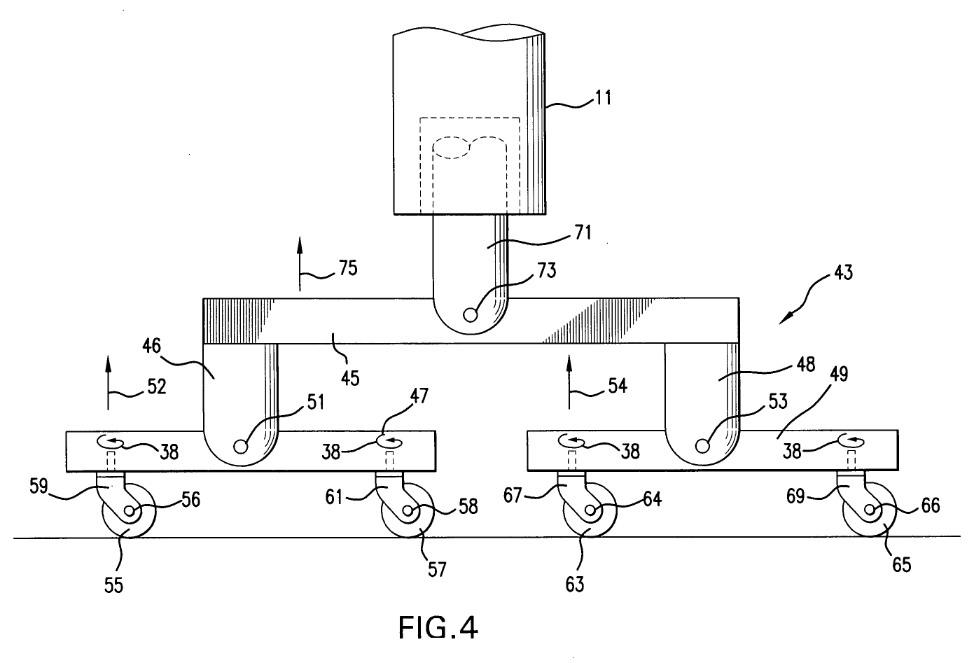

Referencing FIG. 1, a wheeled conveyance, such as the exemplary chair 11, has at the forward portion of its frame structure 12 a tandem axle wheel replacement 13. Also referencing FIG. 2, the tandem axle wheel replacement 13 comprises a carriage 15 for holding a first wheel 17 with a first axle 19 and a second wheel 21 with a second axle 23. The first and second wheels 17, 21 are mounted by first and second casters 25, 27, respectively, which are anchored adjacent the longitudinal ends of the carriage 15. Referring also to FIG. 3, alternatively, first and second spherical wheels 35, 37, respectively, as mounted in first and second spherical wheel assemblies 39, 41, respectively, may be used in a substantially similar system as shown. In either alternative, it will be apparent that the wheels 17, 21 or 35, 37 are mounted so as to swivel and/or roll in any direction when turned about a substantially vertical axis as indicated by the rotary arrows 38.

The tandem axle wheel replacement 13 also comprises a support structure 29 which serves as a means for attachment of the carriage 15 to a wheel-supported body, i.e., a wheeled conveyance, in this instance, a forward leg of the illustrated chair 11. The support structure 29 is rotatably attached to the carriage 15 by a journaled attachment 31 thereby allowing the carriage 15 to pivot about the journaled attachment 31, thus allowing vertical movement of the wheels 17, 21, or 35, 37, as indicated by the arrow 33.

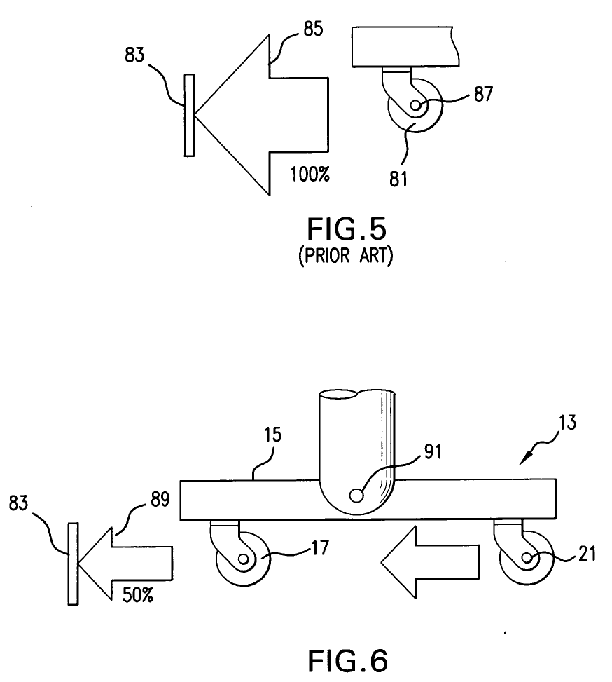

Referring to FIG. 4, a second preferred embodiment of the present invention illustrates a double tandem axle wheel replacement 43. The double tandem axle wheel replacement 43 comprises a first, or primary, carriage 45 being located proximal the wheeled conveyance 11 and having first and second downward descending legs 46, 48. The primary carriage 45 is attached to a first secondary carriage 47 and a second secondary carriage 49, which are rotatably attached via respectivejournaled attachments 51, 53 on the first and second downward descending legs 46, 48 of the primary carriage 45, thereby allowing vertical movement of the first secondary carriage 47 and second secondary carriage 49 as indicated by the arrows 52, 54 respectively.

The first secondary carriage 47 holds a first wheel 55 with a first axle 56 and a second wheel 57 with a second axle 58. The first and second wheels 55, 57 are mounted by first and second casters 59, 61, respectively, which are anchored adjacent the longitudinal ends of the first secondary carriage 47. The second secondary carriage 49 holds a third wheel 63 with a third axle 64 and a fourth wheel 65 with a fourth axle 66. The third and fourth wheels 63, 65 are mounted by third and fourth casters 67, 69, respectively, which are anchored adjacent the longitudinal ends of the second secondary carriage 49.

As is the case in the single tandem axle assemblies of FIGS. 1-3, it will be apparent that, alternatively, spherical wheel assemblies may be used in a substantially similar system as shown. In either alternative, it will be apparent that the wheels 55, 57, 63, 65 are mounted so as to swivel and/or roll in any direction when turned about a substantially vertical axis as indicated by the rotary arrows 38. Alternatively, it will be appreciated that universal joints (not shown) may be substituted for the secondary carriage journal attachments 51, 53 to allow the secondary carriages 47,49 to move in both the vertical and horizontal planes.

The double tandem axle wheel replacement 43 also comprises a support structure 71 which serves as a means for attachment of the primary carriage 45 to a wheeled conveyance, again in this instance, a forward leg of the illustrated chair 11. The support structure 71 is rotatably attached to the primary carriage 45 by ajournaled attachment 73 thereby allowing the primary carriage 45 to pivot about the journaled attachment 73, thus allowing vertical movement of the secondary carriages 47,49 and their wheels 55, 57, 63, 65, as indicated by the arrow 75.

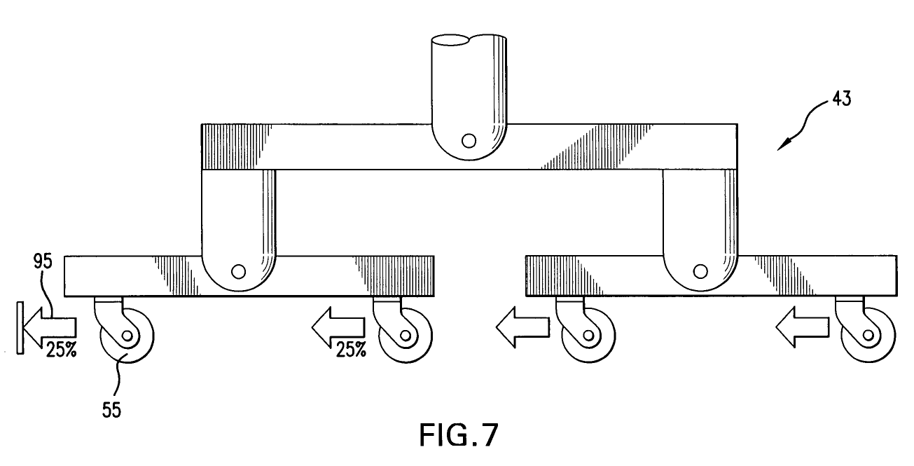

Referring to FIGS. 5-7, there is illustrated a comparison of static horizontal force necessary for a forward wheel of a wheeled conveyance to traverse an obstacle. As seen in FIG. 5, a single wheel 81, when encountering an obstacle 83, assumes 100% of the static horizontal force of the encounter, as indicated by the arrow 85. It will further be appreciated that the single conventional wheel 81 and its axle 87 must rise to the full height of the obstacle 83 as it passes over the obstacle 83. As seen in FIG. 6, the forward wheel 17 of a tandem axle wheel replacement 13, when encountering the obstacle 83, assumes 50% of the static horizontal force of the encounter, as indicated by the arrow 89. Referring also to FIG. 1, it will further be appreciated that the tandem axle wheel replacement 13 allows the wheels, e.g., forward wheel 17, to traverse the obstacle 83 while lifting the center 91 of the tandem axle wheel replacement carriage 15 only one half of the obstruction height as indicated by the arrow 93. As seen in FIG. 7, the forward wheel 55 of the double tandem axle wheel replacement 43, when encountering the obstacle 83, assumes 25% of the static horizontal force of the encounter, as indicated by the arrow 95.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

1. A tandem axle apparatus for replacing a single wheel on a wheeled conveyance, comprising:
a first wheel and a second wheel;
a carriage for holding the first wheel and the second wheel;
the first and second wheels being able to swivel and roll when turned about a substantially vertical axis;
the carriage further having a means for attachment of the carriage to the wheeled conveyance.

2. The tandem axle apparatus according to claim 1 wherein the first wheel is attached to a first axle and the second wheel is attached to a second axle and the wheels are caster mounted.

3. The tandem axle apparatus according to claim 1 wherein the wheels are spherical.

4. The tandem axle apparatus according to claim 1 wherein the means for attachment is a structure rotatably attached to the carriage.

5. The tandem axle apparatus according to claim 4 wherein the means for attachment is journaled to the carriage.

6. The tandem axle apparatus according to claim 1 wherein the means for attachment is mounted to the carriage by a universal joint.

7. The tandem axle apparatus according to claim 1 further comprising:
a double tandem axle wheel replacement apparatus having:
a primary carriage holding a first secondary carriage and a second secondary carriage;
the first secondary carriage and a second secondary carriage each holding a plurality of wheels able to swivel and roll when turned about a substantially vertical axis;
the primary carriage further having a means for attachment of the carriage to the wheeled conveyance.

8. The tandem axle apparatus according to claim 7 wherein the plurality of wheels are caster mounted.

9. The tandem axle apparatus according to claim 7 wherein the plurality of wheels are spherical.

10. The tandem axle apparatus according to claim 7 wherein the means for attachment is a structure rotatably attached to the carriage.

11. The tandem axle apparatus according to claim 10 wherein the means for attachment is journaled to the carriage.

12. The tandem axle apparatus according to claim 7 wherein the means for attachment is mounted to the carriage by a universal joint.

13. A wheeled conveyance, comprising:
a frame structure for the attachment of wheels, the frame structure having an attachment point for at least one of the wheels;
a tandem axle apparatus attached to the attachment point, the tandem axle apparatus including:
a first wheel and a second wheel;
a carriage for holding the first wheel and the second wheel;
the first and second wheels being able to swivel and roll when turned about a substantially vertical axis;
the carriage further having a means for attachment of the carriage to the wheeled conveyance.

14. The wheeled conveyance according to claim 13 wherein:
the tandem axle apparatus is a double tandem axle wheel replacement apparatus including:
a primary carriage holding a first secondary carriage and a second secondary carriage;
the first secondary carriage and a second secondary carriage each holding a plurality of wheels able to swivel and roll when turned about a substantially vertical axis;
the primary carriage further having a means for attachment of the carriage to the wheeled conveyance.

15. The tandem axle apparatus according to claim 13 wherein the plurality of wheels are caster mounted.

16. The tandem axle apparatus according to claim 13 wherein the plurality of wheels are spherical.

17. The tandem axle apparatus according to claim 13 wherein the means for attachment is a structure rotatably attached to the carriage.

18. The tandem axle apparatus according to claim 13 wherein the means for attachment is journaled to the carriage.

19. The tandem axle apparatus according to claim 13 wherein the means for attachment is mounted to the carriage by a universal joint.

20. The tandem axle apparatus according to claim 14 wherein the plurality of wheels are caster mounted.

21. The tandem axle apparatus according to claim 14 wherein the plurality of wheels are spherical.

22. The tandem axle apparatus according to claim 14 wherein the means for attachment is a structure rotatably attached to the carriage.

23. The tandem axle apparatus according to claim 14 wherein the means for attachment is journaled to the carriage.

24. The tandem axle apparatus according to claim 14 wherein the means for attachment is mounted to the carriage by a universal joint.
